(19) United States
(12) Patent Application Publication
(10) Pub. No.: US 2013/0194237 A1
(43) Pub. Date: Aug. 1, 2013

(54) PRESSURE SENSOR AND APPARATUS FOR SENSING PRESSURE AND TOUCH SCREEN INCLUDING THE SAME

(71) Applicant: Electronics and Telecommunications Research, Daejeon (KR)

(72) Inventors: Ki Uk KYUNG, Daejeon (KR); Sun Tak PARK, Daejeon (KR); Young Sung KIM, Daejeon (KR); Jun Seok PARK, Daejeon (KR)

(73) Assignee: Electronics and Telecommunications Research Institute, Daejeon (KR)

(21) Appl. No.: 13/707,559

(22) Filed: Dec. 6, 2012

(30) Foreign Application Priority Data
Jan. 26, 2012 (KR) 10-2012-0007818
Apr. 2, 2012 (KR) 10-2012-0034122

(51) Int. Cl. G01L 1/24; G06F 3/042

(52) U.S. Cl. CPC G01L 1/24; G06F 3/0421
USPC 345/175; 73/862.624

(57) ABSTRACT

Disclosed is a film or a panel that may measure pressure while interacting with an electronic device. A pressure sensor according to the present invention includes: a light source unit to generate light; an optical waveguide to transfer, to a light receiving unit, the light that is generated by the light source unit; and the light receiving unit to receive the light that is transferred through the optical waveguide. The optical waveguide includes a pressure sensing unit to adjust the quantity of light that is transferred through the optical waveguide based on a pressure. The light receiving unit senses the pressure based on the change in the quantity of light that is generated by the light source unit and is transferred through the optical waveguide.

### CROSS-REFERENCE TO RELATED APPLICATIONS

This application claims priority to and the benefit of Korean Patent Application No. 10-2012-0007818 filed in the Korean Intellectual Property Office on Jan. 26, 2012, and Korean Patent Application No. 10-2012-0034122 filed in the Korean Intellectual Property Office on Apr. 2, 2012, the entire contents of which are incorporated herein by reference.

### TECHNICAL FIELD

The present invention relates to a film or a panel that may measure pressure while interacting with an electronic device, and more particularly, to a technology of measuring pressure on a touch screen.

### BACKGROUND ART

The related art includes a method of measuring pressure by mounting a pressure sensor at a lower end of a touch screen or by employing an external apparatus, and the like. Korea Patent Application No. 2008-0092059 discloses a method of measuring pressure for controlling a touch screen by mounting a pressure sensor in a lower end of the touch screen, or measuring the pressure using an external touch pressure sensing pen. However, in the case of the above method, since the pressure sensor is disposed in the lower end of the touch screen, it is impossible to directly measure the pressure. When pressure occurs at a plurality of locations simultaneously, it is difficult to accurately measure a corresponding location and pressure value.

### SUMMARY OF THE INVENTION

The present invention has been made in an effort to provide an apparatus that may increase a direct pressure measurement effect by installing a transparent film type pressure sensor in an upper end of a screen and may also measure an accurate location and a corresponding pressure value even though pressure occurs at a plurality of locations simultaneously.

The present invention also has been made in an effort to an apparatus that enable a single pressure sensor to simultaneously measure a location and a pressure, and may only use a movement path of light without using an electrical wire in a predetermined pressure portion and thus, may be easily designed compared to a scheme of measuring a change in an amount of charge.

An exemplary embodiment of the present invention provides a pressure sensor including: a light source unit to generate light; an optical waveguide to transfer, to a light receiving unit, the light that is generated by the light source unit; and the light receiving unit to receive the light that is transferred through the optical waveguide. The optical waveguide may include a pressure sensing unit to adjust the quantity of light that is transferred through the optical waveguide based on a pressure.

The pressure sensing unit may include: a pressurizing layer to which pressure is applied; and an optical waveguide layer through which the light passes. The light receiving unit may sense the pressure based on a change in the quantity of light between the generated light and the transferred light that occurs due to a difference between a refractive index of the pressurizing layer and a refractive index of the optical waveguide layer.

The pressurizing layer and the optical waveguide layer of the pressure sensing unit may be formed to be spaced apart from each other, and the pressurizing layer may contact with the separate optical waveguide layer due to the pressure applied to the pressurizing layer.

The light that passes through the optical waveguide layer may be refracted by, scattered over, or absorbed into the pressuring layer as the pressurizing layer and the optical waveguide layer that are spaced apart from each other contact with each other due to the applied pressure.

The difference between the refractive index of the pressurizing layer and the refractive index of the optical waveguide layer may indicate that the refractive index of the pressurizing layer is higher than or equal to the refractive index of the optical waveguide layer.

A contact area between the pressurizing layer and the optical waveguide layer may vary based on magnitude of the pressure that is applied to the pressurizing layer, and the quantity of the refracted, scattered, or absorbed light may vary based on the contact area.

The pressure sensing unit may further include: a support layer to prevent refraction, scattering, or absorption of the light that passes through the optical waveguide layer, and to enable the pressurizing layer and the optical waveguide layer to be spaced apart from each other; and a base layer to prevent refraction, scattering, or absorption of the light that passes through the support layer and the optical waveguide layer.

The pressurizing layer may further include a protruding portion protruded toward a space of the support layer formed between the pressurizing layer and the optical waveguide layer that are spaced apart from each other, to contact with the optical waveguide layer due to the pressure.

A refractive index of each of the support layer and the base layer may be lower than the refractive index of the optical waveguide layer.

Another exemplary embodiment of the present invention discloses an apparatus for sensing pressure, including: a pressurizing layer to which the pressure is applied; and an optical waveguide layer through which light passes. The pressure may be sensed based on a change in the quantity of the generated light that occurs due to a difference between a refractive index of the pressurizing layer and a refractive index of the optical waveguide layer.

The pressurizing layer and the optical waveguide layer of the pressure sensing unit may be formed to be spaced apart from each other, and the pressurizing layer may contact with the separate optical waveguide layer due to the pressure applied to the pressurizing layer.

The light that passes through the optical waveguide layer may be refracted by, scattered over, or absorbed into the pressuring layer as the pressurizing layer and the optical waveguide layer that are spaced apart from each other contact with each other due to the applied pressure.

The difference between the refractive index of the pressurizing layer and the refractive index of the optical waveguide layer may indicate that the refractive index of the pressurizing layer is higher than or equal to the refractive index of the optical waveguide layer.

A contact area between the pressurizing layer and the optical waveguide layer may vary based on magnitude of the pressure that is applied to the pressurizing layer, and the quantity of the refracted, scattered, or absorbed light may vary based on the contact area.

The pressure sensing unit may further include: a support layer to prevent refraction, scattering, or absorption of the light that passes through the optical waveguide layer, and to enable the pressurizing layer and the optical waveguide layer to be spaced apart from each other; and a base layer to prevent refraction, scattering, or absorption of the light that passes through the support layer and the optical waveguide layer.

The pressurizing layer may further include a protruding portion protruded toward a space of the support layer formed between the pressurizing layer and the optical waveguide layer that are spaced apart from each other, to contact with the optical waveguide layer due to the pressure.

A refractive index of each of the support layer and the base layer may be lower than the refractive index of the optical waveguide layer.

Still another exemplary embodiment of the present invention provides a touch screen including: a touch sensor to recognize a location of a touch input by recognizing the touch input; and a pressure sensor to sense pressure of the touch input using the quantity of light that is generated by a light source unit and is transferred to a light receiving unit through an optical waveguide.

The pressure sensor may include: the light source unit to generate the light; the optical waveguide to transfer, to the light receiving unit, the light that is generated by the light source unit; and the light receiving unit to receive the light that is transferred through the optical waveguide. The optical waveguide may include a pressure sensing unit to adjust the quantity of light that is transferred through the optical waveguide based on a pressure.

The pressure sensing unit may include: a pressurizing layer to which the pressure is applied; and an optical waveguide layer through which the light passes. The light receiving unit may sense the pressure based on a change in the quantity of light between the generated light and the transferred light that occurs due to a difference between a refractive index of the pressurizing layer and a refractive index of the optical waveguide layer.

The pressurizing layer and the optical waveguide layer of the pressure sensing unit may be formed to be spaced apart from each other, and the pressurizing layer may contact with the separate optical waveguide layer due to the pressure applied to the pressurizing layer.

According to exemplary embodiments of the present invention, it is possible to easily design and manufacture a pressure sensor by sensing pressure based on the quantity of light without using an electrical wire, and to directly install the pressure sensor in an upper end of a screen by manufacturing the pressure sensor using a material having excellent permeability. Accordingly, it is possible to more accurately measure the pressure. Further, when applying the pressure sensor to a touch screen together with a touch sensor for recognizing a location at which the pressure is applied, it is possible to configure a feeling of writing using the pressure and to perform a realistic control by recognizing magnitude of the pressure and the applied location.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a perspective view illustrating a structure of a pressure sensor according to an exemplary embodiment of the present invention.

FIG. 2 is a cross-sectional view illustrating a pressure sensing unit of the pressure sensor according to an exemplary embodiment of the present invention.

FIG. 3 is a cross-sectional view illustrating a cross-section of the pressure sensing unit of the pressure sensor according to an exemplary embodiment of the present invention.

FIGS. 4A and 4B are cross-sectional views illustrating an example of a pressure sensing principle of the pressure sensing unit of the pressure sensor according to an exemplary embodiment of the present invention.

FIGS. 5A and 5B are cross-sectional views illustrating a modification example of a protruding portion of the pressure sensing unit of the pressure sensor according to an exemplary embodiment of the present invention.

FIGS. 6A and 6B are cross-sectional views illustrating a modification example of the pressure sensing unit of the pressure sensor according to an exemplary embodiment of the present invention.

FIGS. 7A and 7B are perspective views illustrating a structure of the pressure sensor using a single light source and a single sensor according to an exemplary embodiment of the present invention.

FIGS. 8A and 8B are perspective views illustrating a structure of a touch sensor including the pressure sensor according to an exemplary embodiment of the present invention.

FIG. 9 is a perspective illustrating an example of configuring a writing using the pressure sensor according to an exemplary embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter, exemplary embodiments of the present invention will be described in detail with reference to the accompanying drawings. First of all, we should note that in giving reference numerals to elements of each drawing, like reference numerals refer to like elements even though like elements are shown in different drawings. In describing the present invention, well-known functions or constructions will not be described in detail since they may unnecessarily obscure the understanding of the present invention. It should be understood that although exemplary embodiment of the present invention are described hereafter, the spirit of the present invention is not limited thereto and may be changed and modified in various ways by those skilled in the art.

FIG. 1 is a perspective view illustrating a structure of a pressure sensor 10 according to an exemplary embodiment of the present invention. Referring to FIG. 1, the pressure sensor 10 includes a light source unit 100, an optical waveguide 200, and a light receiving unit 300. Further, the optical waveguide 200 includes a pressure sensing unit 210.

The light source unit 100 generates light and functions as a source of generating the light and inputting the light into the optical waveguide 200. A variety of devices of generating the light may be used for the light source unit 100. When applying the light source unit 100 to a transparent pressure sensor desired by the present invention, an infrared (IR) light source may be used so that the light may be invisible to eyes.

The optical waveguide 200 transfers, to the light receiving unit 300, the light that is generated by the light source unit 100. Further, the optical waveguide 200 is a passage that is designed within a base unit of the pressure sensor 10 to transmit the light. In general, when an optical refractive index of a material constituting the optical waveguide 200 is higher than a refractive index of a material of the base unit, the light that is incident to the optical waveguide 200 does not leak into the base unit and moves along only the optical waveguide 200.

The light receiving unit 300 senses pressure based on a change in the quantity of light that is generated by the light source unit 100 and is transferred through the optical waveguide 200, and measures the quantity of light that is transferred through the optical waveguide 200. As a sensor of measuring the light having passed through the optical waveguide 200 and the pressure sensing unit 210, a plurality of pressure sensing units 210 distributed on the base unit individually measures the changed quantity of light. Here, when a large number of pressure sensing units 210 are provided to measure an individual pressure at a variety of locations, the optical waveguide 200 is also disposed to be complex. In general, the size of the optical waveguide 200 is less than or equal to tens of micrometers and thus, there is no spatial problem in constituting the pressure sensor 10 having high spatial resolution. However, the light receiving unit 300 needs to individually measure an output value of the optical waveguide 200 as many as the number of the pressure sensing units 210. Accordingly, in addition to a method of disposing a plurality of optical sensors, it is possible to measure an individual output at one time using an image sensor such as a charge coupled device (CCD), a complementary metal oxide semiconductor (CMOS), and the like. Hereinafter, the pressure sensing unit 210 of the pressure sensor 10 according to the exemplary embodiment will be described.

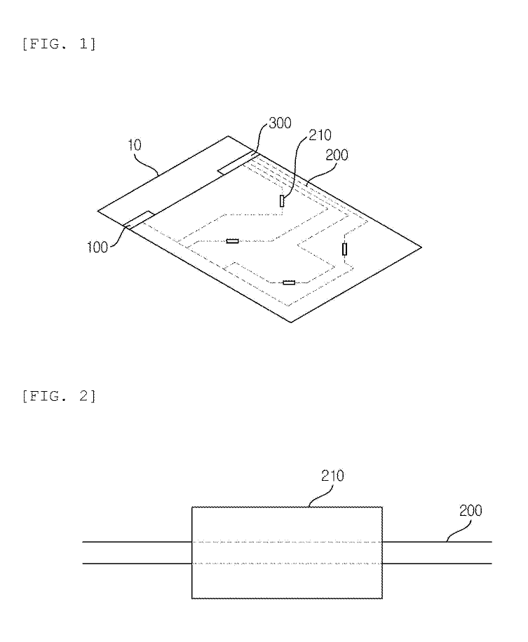

The pressure sensing unit 210 adjusts the quantity of light that is transferred through the optical waveguide 200 based on the pressure. Referring to FIG. 2, the optical waveguide 200 passes through a lower end of the pressure sensing unit 210. A contact state between the pressure sensing unit 210 and the optical waveguide 200 varies based on the pressure and the pressure sensing unit 200 adjusts the quantity of light that is transferred through the optical waveguide 200. Hereinafter, it will be further described in detail with reference to the accompanying drawings.

FIG. 3 is a cross-sectional view illustrating a cross-section of the pressure sensing unit 210 of the pressure sensor 10 according to an exemplary embodiment of the present invention. Referring to FIG. 3, the pressure sensing unit 210 according to the exemplary embodiment includes a pressurizing layer 212, an optical waveguide layer 216, a support layer 214, and a base layer 218.

The pressurizing layer 212 is a portion to which the pressure is applied, and contacts with the optical waveguide layer 216 while the pressurizing layer 212 is moving downward due to the pressure applied to the pressurizing layer 212. The optical waveguide layer 216 is a portion through which the light passes and the light generated by the light source unit 100 substantially passes through.

Further, in the exemplary embodiment, the pressurizing layer 212 may further include a protruding portion 213 protruded toward a space of the support layer formed between the pressurizing layer 212 and the optical waveguide layer 216 that are spaced apart from each other, to contact with the optical waveguide layer 216 due to the pressure.

The support layer 214 may prevent refraction, scattering, or absorption of the light that passes through the optical waveguide layer 216, and enables the pressurizing layer 212 and the optical waveguide layer 216 to be spaced apart from each other. The support layer 214 is disposed on the optical waveguide 216 and includes a material having a refractive index less than a refractive index of the optical waveguide layer 216. Accordingly, the support layer 214 enables the light to move through only the optical waveguide layer 216, and enables a portion of the pressurizing portion 212 on which an external pressure works to be spaced apart from the optical waveguide layer 216. The base layer 218 includes a material having a relatively low refractive index, and prevents refraction, scattering, or absorption of the light that passes through the support layer 214 and the optical waveguide 216 and is disposed below the optical waveguide 216. Each of the aforementioned layers only needs to secure a thickness at which light may pass through or be reflected. Therefore, considering that a wavelength of light is hundreds of nanometers, each layer may be manufactured to have a thickness less than or equal to tens of micrometers. Hereinafter, a pressure sensing method of the pressure sensing unit 210 according to the exemplary embodiment will be described in detail.

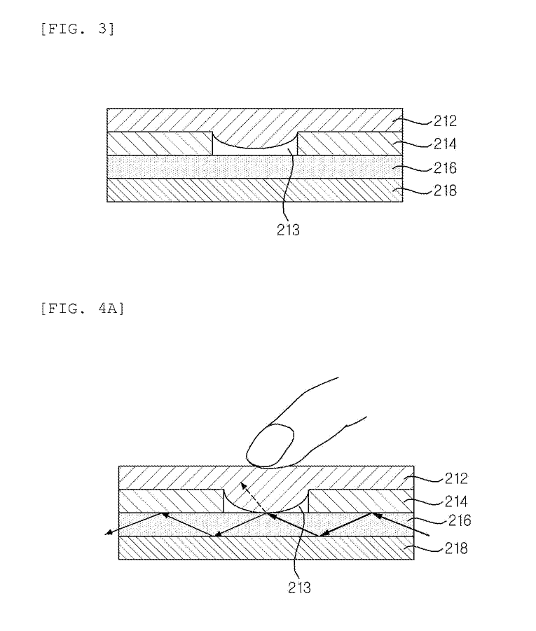

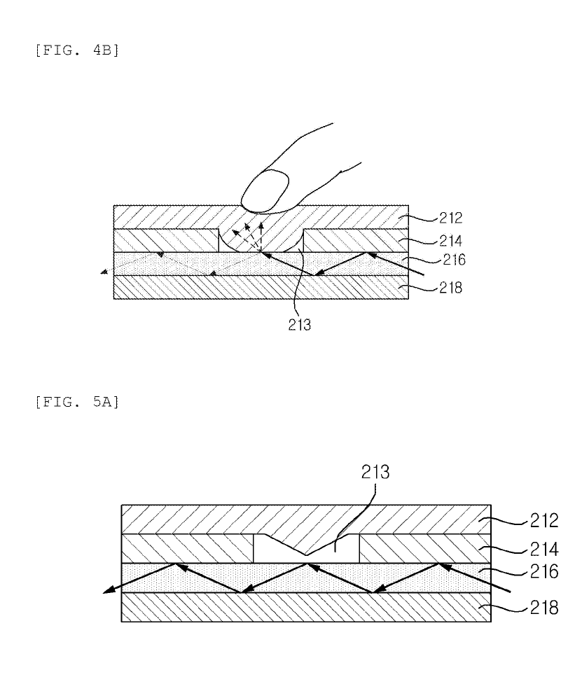

FIGS. 4A and 4B are cross-sectional views illustrating an example of a method of sensing pressure by the pressure sensing unit 210 according to an exemplary embodiment of the present invention. Referring to FIGS. 4A and 4B, when the pressure is applied, the pressuring layer 212 contacts with the optical waveguide layer 216 spaced apart from the pressuring layer 212 due to the pressure applied to the pressurizing layer 212, thereby changing the quantity of light that passes through the optical waveguide layer 216. Based thereon, the pressure sensing unit 210 senses the pressure. In the exemplary embodiment, the change in the quantity of light occurs since the light being transferred through the optical waveguide 216 is refracted by, scattered over, or absorbed into the pressurizing layer 212 as the pressurizing layer 212 and the optical waveguide layer 216 that are spaced apart from each other contact with each other due to the pressure applied to the pressurizing layer 212.

Referring to FIG. 4A, the pressurizing layer 212 has the protruding portion 213. When the pressure is applied to the pressurizing layer 212, the pressurizing layer 212 contacts with the optical waveguide layer 216 in such a manner that the protruding portion 213 moves downward. Here, a refractive index of a material of the pressurizing layer 212 is greater than a refractive index of a material of the optical waveguide layer 216. Accordingly, a portion of the light moving along the optical waveguide layer 216 is refracted, scattered, or absorbed while passing through a contact surface with a cover layer. Accordingly, an amount of light that is transferred to the light receiving unit 300 through the optical waveguide layer 216 partially decreases.

Further, referring to FIG. 4B, a contact area between the pressurizing layer 212 and the optical waveguide layer 216 varies based on magnitude of the pressure that is applied to the pressurizing layer 212. The quantity of the refracted, scattered, or absorbed light varies based on the contact area. Accordingly, when a further strong pressure is applied, a change may occur in a shape of the pressurizing layer 212 and the protruding portion 213 formed using a flexible property such as an elastic substance, whereby the contact area between the protruding portion 213 and the optical waveguide layer 216 increases. Accordingly, an amount of light that is lost due to leakage or scattering increases and an amount of light that is transferred to the light receiving unit 300 through the pressurizing layer 212 decreases.

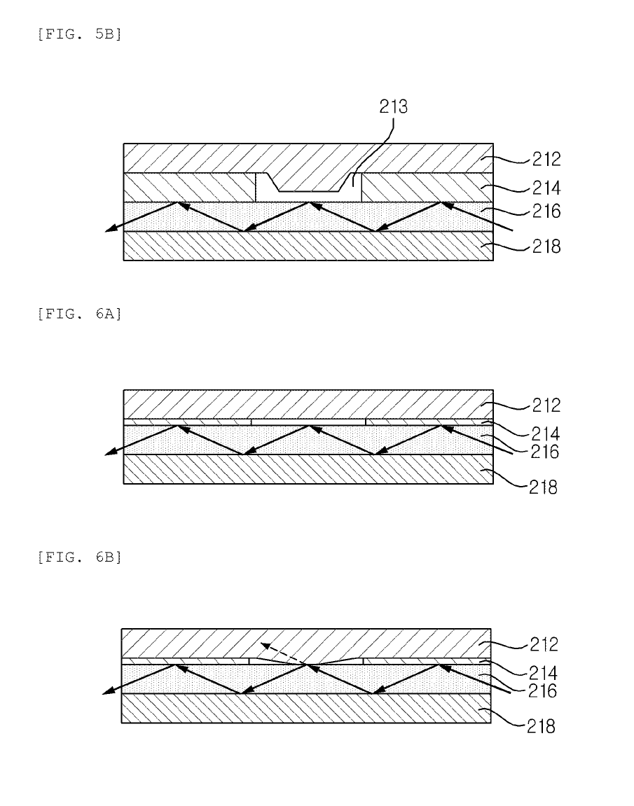

Therefore, using the aforementioned principle, the pressure sensor 10 according to the exemplary embodiment may vary a width in which a material having a high refractive index contacts with the optical waveguide 200, based on the change in the pressure and thereby change the quantity of light that is transferred along the optical waveguide 200. The light receiving unit 300 may predict the change in the pressure by measuring the change in the quantity of finally transferred light. Further, the pressure sensor 10 according to the exemplary embodiment may also measure magnitude of the pressure using a relationship between the pressure and the quantity of lost light in the quantity of light that is lost due to an increase in the contact area between the protruding portion 213 of the pressurizing layer 212 and the optical waveguide layer 216 based on the pressure. In addition, referring to FIGS. 5A and 5B, the shape of the protruding portion 213 of the pressurizing layer 212 according to the exemplary embodiment may be variously modified. A characteristic of the present invention lies in that the pressurizing layer 212 having flexibility is modified by the pressure to thereby vary an area of the contact surface between the protruding portion 213 and the optical waveguide 200. To advantageously modify the shape of the contact surface, the shape of the protruding portion 213 may be designed as illustrated in FIG. 5A or 5B. Furthermore, a variety of structures that may modify and thereby increase the contact surface based on the pressure may be applied.

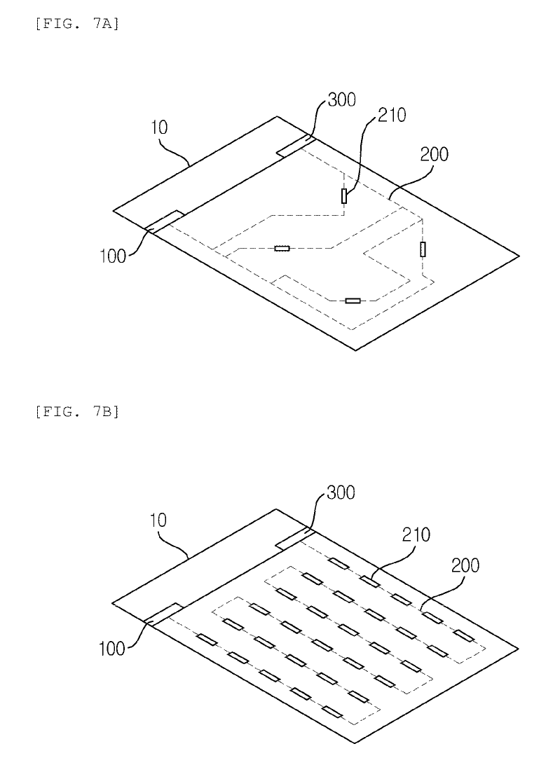

Further, the pressure sensing unit 210 according to the exemplary embodiment may be configured not to include the protruding portion 213. FIGS. 6A and 6B are cross-sectional views illustrating a structure modification of the pressure sensing unit 210 not to form the protruding portion 213 through modification in a thickness of the support layer 214. As illustrated in FIGS. 6A and 6B, when the support layer 214 is disposed to have a thin thickness compared to the support layer 214 of the pressure sensing unit 210 of FIG. 4 or FIG. 5, it is possible to induce the change in the quantity of transferred light based on the pressure using the principle of the aforementioned pressure sensing method, without a need to form the separate protruding portion 213 on the pressurizing layer 212. In addition, the thickness of the support layer 214 may be adjusted based on a flexibility level of the pressurizing layer 212.

When the thickness of the support layer 214 is formed to be thin as illustrated in FIG. 6A, it is possible to form the contact surface between the pressurizing unit 212 and the optical waveguide layer 216 through a groove formed in the support layer 214 without forming a protruding structure such as the protruding portion 213 on the pressurizing layer 212 as illustrated in FIG. 6B. In addition, the width of the contact surface between the pressurizing layer 212 and the optical wavelength layer 216 becomes wider according to an increase in the pressure and thus, a further large amount of light leaks out and thereby is scattered or lost.

Further, even though not illustrated, the pressure sensing unit 210 according to the exemplary embodiment does not include the support layer 214 and may induce loss of light that is transferred through the optical waveguide layer 216 due to the pressure applied to the pressurizing layer 212, using the pressurizing layer 212 and the optical waveguide layer 216 that are spaced apart from each other based on a different principle. Hereinafter, a structure of the pressurizing sensor 10 according to the exemplary embodiment will be described.

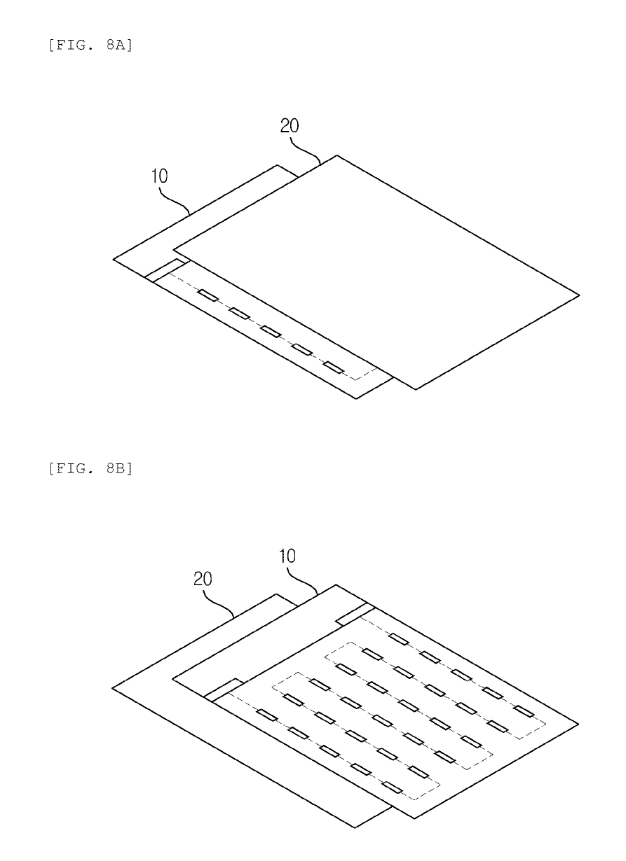

Referring to FIG. 7A, the pressure sensor 10 may be configured using a single light source and a single sensor. Depending on aim of a user, there is no need to measure a location at which the pressure is measured and only a pressure value may be required. In this case, as illustrated in FIGS. 7A and 7B, all of the light that has passed through the pressure sensing unit 210 meets at a single optical waveguide 200 before reaching the light receiving unit 300. Through this, attenuated light is enabled to be measured. Accordingly, by installing a single optical quantity sensor in the light receiving unit 300, it is possible to configure the pressure sensor 10 that measures only magnitude of the pressure excluding a location of the pressure. Accordingly, the pressure sensor 10 as illustrated in FIGS. 7A and 7B has economical effect in a cost and signal processing method.

FIG. 7B is a perspective view illustrating a design modification of the pressure sensor 10 using the single light source and the single sensor of FIG. 7A. As illustrated in FIG. 7B, in a case in which it is an aim to measure only the pressure applied from outside regardless of a location, a method of disposing the single optical waveguide 200 to be continuous and in this instance, disposing the single optical waveguide 200 to be uniformly spread over the base unit may be used. Here, when the pressure sensing units 210 are uniformly and densely distributed, it is possible to predict a pressure value pushed by a user, regardless of a location pushed by the user. In this case, while location localization is impossible, the pressure sensing unit 210 may be used as a pressure sensor of measuring the pressure regardless of a location at which the external pressure is applied on the whole surface. Hereinafter a touch screen including the pressure sensor 10 according to another exemplary embodiment of the present invention will be described.

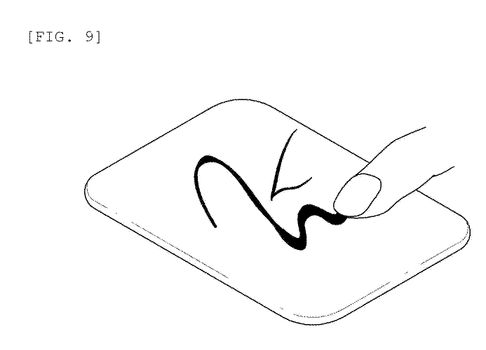

FIGS. 8A and 8B are perspective views illustrating a touch screen including the pressure sensor 10 according to an exemplary embodiment of the present invention. The pressure sensor 10 according to the aforementioned exemplary embodiment may measure the pressure by an external force even though the external force is applied at any location on the whole surface of the pressure sensor 10, however, may not measure a location at which the pressure is applied. To complement the above aspect, a method of co-using a touch sensor 20 capable of measuring a contact location may be used as illustrated in FIGS. 8A and 8B.

The touch sensor 20 is an input/output means to perform overall control of an electronic device including controlling of a display screen by sensing a contact location of a user on a display screen and receiving information about the sensed contact location, and is an apparatus for recognizing a contact as an input signal when an object such as a finger, a touch pen, and the like is contacted on the screen. The touch sensor 20 may be manufactured using an ultrasound wave, an IR, a resistance film, a capacitance scheme, and the like. Therefore, by disposing the touch sensor 20 on the pressure sensor 10 proposed in FIG. 7B as illustrated in FIG. 8A, or by disposing the touch sensor 20 below the pressure sensor 10 as illustrated in FIG. 8B, it is possible to measure each of a location at which the pressure is applied by the external force and magnitude of the pressure.

Using the pressure sensor 10 and the touch sensor 20 manufactured in the simple structure according to the above principle, it is possible to configure the pressure sensor 10 that may measure even a local location by employing the minimum number of sensors in the light receiving unit 300, instead of arranging the number of sensors of the light receiving unit 300 as many as the number of pressure sensing units 210.

Further, a method of employing a pressure sensor according to an exemplary embodiment of the present invention as a touch button may be used. When a user contacts with a touch button using a finger, a change occurs in the quantity of light that is transferred through a pressure sensing unit according to the exemplary embodiment. The change is recognized as magnitude of pressure. Among finger contacts of the user, a finger contact that applies pressure of greater than or equal to a first threshold and less than or equal to a second threshold is recognized as a “touch” corresponding to an input required by the existing touch sensor 20. A case in which a finger contact of the user that applies pressure of greater than or equal to the second threshold and less than or equal to a third threshold is measured may be determined as a case in which the user has applied the finger contact with intent of the user. Accordingly, in this case, it is possible to transfer a realistic button feeling to the user by interacting with a tactile output (haptic) that generates a feeling of a button. In addition, a case in which a finger contact of the user that applies pressure of greater than or equal to the second threshold is measured may be determined as a case in which the user has applied the finger contact with strong intent. Accordingly, in this case, it is possible to configure another strong button feeling having a realistic feeling for the user, by interacting with the tactile output that generates a feeling of a button different from the aforementioned button.

In addition, it is possible to interact with acoustic effect, visual effect, and the like as well as tactile effect, by interacting with the magnitude of the pressure.

Further, FIG. 9 is a perspective illustrating an example of configuring a writing using a pressure sensor according to an exemplary embodiment of the present invention. Referring to FIG. 9, when a touch screen capable of measuring the pressure is configured, a user may move a location at which the pressure is applied while adjusting the pressure on the touch screen. Accordingly, the user may reflect and thereby express a thickness or a concentration of a line based on the pressure in an operation of drawing a picture and the like. In addition, the pressure recognition of the pressure sensor 10 according to the exemplary embodiment may be used to process a feeling of writing, handwriting, a picture, a signature, and the like on the touch screen.

As described above, the exemplary embodiments have been described and illustrated in the drawings and the specification. The exemplary embodiments were chosen and described in order to explain certain principles of the invention and their practical application, to thereby enable others skilled in the art to make and utilize various exemplary embodiments of the present invention, as well as various alternatives and modifications thereof. As is evident from the foregoing description, certain aspects of the present invention are not limited by the particular details of the examples illustrated herein, and it is therefore contemplated that other modifications and applications, or equivalents thereof, will occur to those skilled in the art. Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

What is claimed is:

1. A pressure sensor comprising:
a light source unit to generate light;
an optical waveguide to transfer, to a light receiving unit, the light that is generated by the light source unit; and
the light receiving unit to receive the light that is transferred through the optical waveguide,
wherein the optical waveguide includes a pressure sensing unit to adjust the quantity of light that is transferred through the optical waveguide based on a pressure.

2. The pressure sensor of claim 1, wherein the pressure sensing unit includes:
a pressurizing layer to which the pressure is applied; and
an optical waveguide layer through which the light passes, and
the light receiving unit senses the pressure based on a change in the quantity of light between the generated light and the transferred light that occurs due to a difference between a refractive index of the pressurizing layer and a refractive index of the optical waveguide layer.

3. The pressure sensor of claim 2, wherein:
the pressurizing layer and the optical waveguide layer of the pressure sensing unit are formed to be spaced apart from each other, and
the pressurizing layer contacts with the separate optical waveguide layer due to the pressure applied to the pressurizing layer.

4. The pressure sensor of claim 3, wherein the light that passes through the optical waveguide layer is refracted by, scattered over, or absorbed into the pressuring layer as the pressurizing layer and the optical waveguide layer that are spaced apart from each other contact with each other due to the applied pressure.

5. The pressure sensor of claim 2, wherein the difference between the refractive index of the pressurizing layer and the refractive index of the optical waveguide layer indicates that the refractive index of the pressurizing layer is higher than or equal to the refractive index of the optical waveguide layer.

6. The pressure sensor of claim 4, wherein:
a contact area between the pressurizing layer and the optical waveguide layer varies based on magnitude of the pressure that is applied to the pressurizing layer, and the quantity of the refracted, scattered, or absorbed light varies based on the contact area.

7. The pressure sensor of claim 3, wherein the pressure sensing unit further includes:
a support layer to prevent refraction, scattering, or absorption of the light that passes through the optical waveguide layer, and to enable the pressurizing layer and the optical waveguide layer to be spaced apart from each other; and
a base layer to prevent refraction, scattering, or absorption of the light that passes through the support layer and the optical waveguide layer.

8. The pressure sensor of claim 7, wherein the pressurizing layer further includes:
a protruding portion protruded toward a space of the support layer formed between the pressurizing layer and the optical waveguide layer that are spaced apart from each other, to contact with the optical waveguide layer due to the pressure.

9. The pressure sensor of claim 7, wherein a refractive index of each of the support layer and the base layer is lower than the refractive index of the optical waveguide layer.

10. An apparatus for sensing a pressure, comprising:
a pressurizing layer to which the pressure is applied; and
an optical waveguide layer through which light passes,
wherein the pressure is sensed based on a change in the quantity of the generated light that occurs due to a difference between a refractive index of the pressurizing layer and a refractive index of the optical waveguide layer.

11. The apparatus of claim 10, wherein:
the pressurizing layer and the optical waveguide layer of the pressure sensing unit are formed to be spaced apart from each other, and
the pressurizing layer contacts with the separate optical waveguide layer due to the pressure applied to the pressurizing layer.

12. The apparatus of claim 11, wherein the light that passes through the optical waveguide layer is refracted by, scattered over, or absorbed into the pressuring layer as the pressurizing layer and the optical waveguide layer that are spaced apart from each other contact with each other due to the applied pressure.

13. The apparatus of claim 10, wherein the difference between the refractive index of the pressurizing layer and the refractive index of the optical waveguide layer indicates that the refractive index of the pressurizing layer is higher than or equal to the refractive index of the optical waveguide layer.

14. The apparatus of claim 12, wherein:
a contact area between the pressurizing layer and the optical waveguide layer varies based on magnitude of the pressure that is applied to the pressurizing layer, and
the quantity of the refracted, scattered, or absorbed light varies based on the contact area.

15. The apparatus of claim 12, wherein the pressure sensing unit further includes:
a support layer to prevent refraction, scattering, or absorption of the light that passes through the optical waveguide layer, and to enable the pressurizing layer and the optical waveguide layer to be spaced apart from each other; and
a base layer to prevent refraction, scattering, or absorption of the light that passes through the support layer and the optical waveguide layer.

16. The apparatus of claim 15, wherein the pressurizing layer further includes:
a protruding portion protruded toward a space of the support layer formed between the pressurizing layer and the optical waveguide layer that are spaced apart from each other, to contact with the optical waveguide layer due to the pressure.

17. The apparatus of claim 15, wherein a refractive index of each of the support layer and the base layer is lower than the refractive index of the optical waveguide layer.

18. A touch screen comprising:
a touch sensor to recognize a location of a touch input by recognizing the touch input; and
a pressure sensor to sense pressure of the touch input using the quantity of light that is generated by a light source unit and is transferred to a light receiving unit through an optical waveguide.

19. The touch screen of claim 18, wherein the pressure sensor includes:
the light source unit to generate the light;
the optical waveguide to transfer, to the light receiving unit, the light that is generated by the light source unit; and
the light receiving unit to receive the light that is transferred through the optical waveguide, and
the optical waveguide includes a pressure sensing unit to adjust the quantity of light that is transferred through the optical waveguide based on a pressure.

20. The touch screen of claim 19, wherein the pressure sensing unit includes:
a pressurizing layer to which the pressure is applied; and
an optical waveguide layer through which the light passes, and
the light receiving unit senses the pressure based on a change in the quantity of light between the generated light and the transferred light that occurs due to a difference between a refractive index of the pressurizing layer and a refractive index of the optical waveguide layer.
